(19) United States
(12) Patent Application Publication
(10) Pub. No.: US 2009/0098247 A1
(43) Pub. Date: Apr. 16, 2009

(54) LACTIC ACID-FERMENTED SOYBEAN LIQUID COMPOSITION AND METHOD FOR PRODUCTION THEREOF

(75) Inventor: Toshinori IGARASHI, Chiba (JP)

Correspondence Address: YOUNG & THOMPSON, 209 Madison Street, Suite 500, ALEXANDRIA, VA, 22314, US

(73) Assignee: KIKKOMAN CORPORATION, Noda-shi (JP)

(21) Appl. No.: 12/252,501

(22) Filed: Oct. 16, 2008

(30) Foreign Application Priority Data
Oct. 16, 2007 (JP) 2007-269150

(51) Int. Cl. A23C 11/10; A23L 1/20

(52) U.S. Cl. 426/46; 426/634

(57) ABSTRACT

The lactic acid-fermented soybean liquid composition according to the present invention is obtained by adding lactic acid bacteria to a soybean liquid in which the content of the soybean particles having a particle size of 50 μm or larger is less than 5%, and subjecting the resulting composition to lactic acid-fermentation in the presence of one or two or more kinds of alkaline metal salts at 230 ppm or more in terms of alkaline metal(s). The lactic acid-fermented soybean liquid composition preferably has a content of the particles derived from soybeans having a particle size of 100 μm or larger of less than 1% of all particles, a pH of 3.0 to 5.5, and a breaking strength of 9.0 gf or lower.

### BACKGROUND OF THE INVENTION

1. Field of the Invention

The present invention relates to a lactic acid-fermented soybean liquid composition which is free of a rough texture on the tongue resulting from soybean powder, is smooth, and has good melting feeling in the mouth and soft texture despite the use of soybean powder, and a method for production thereof.

2. Description of the Related Art

It has conventionally been known that a yoghurt-like fermented soybean food is obtained by subjecting soybeans to a moist heat treatment at nearly 100° C. and a grinding treatment to obtain soybean powder, mixing the soybean powder thus obtained with water, heating the mixture, homogenizing the mixture with a high-pressure homogenizer, heat-sterilizing the mixture to prepare a soybean liquid, and adding lactic acid bacteria to the soybean liquid to allow lactic acid fermentation to cause (See, for example, Patent Document 1).

For this method, however, a particle size distribution of the soybean liquid is neither described nor suggested. In fact, the soybean liquid obtained by the method contains large amounts of water-insoluble components, fibers, particles having large particle sizes, etc., which are derived from the hull of raw material soybeans; and has drawbacks that when the liquid is lactic acid-fermented, floc formation occurs due to soybean-derived particles with the progress of fermentation (a reduction in pH), and the flocs further bind each other to undergo gelation. According to the investigation of the present inventors, the lactic acid-fermented soybean liquid composition obtained by lactic acid fermentation of such a soybean liquid has a rough texture on the tongue resulting from soybean powder. In this respect, there is room for improvement of, for example, smoothness and melting feeling in the mouth when taken the lactic acid-fermented soybean liquid composition as food or drink. Furthermore, there is no description of adding salt to a soybean liquid in this method.

On the other hand, a method for obtaining a yoghurt-like fermented soy food is known, in which 9 to 13 parts of soybean powder is mixed with 91 to 87 parts of water to prepare a soybean liquid, 0.3 to 0.5% of lactose and 0.05 to 0.2% of sodium chloride are added to the soybean liquid, the resulting mixture is processed by heat sterilization, and lactic acid bacteria are then added to the soybean liquid to cause lactic acid fermentation (See, for example, Patent Document 2). In other words, a method for obtaining a yoghurt-like fermented soy food wherein salt is added to a soybean liquid is described.

Even for this method, however, there is no description concerning a particle size distribution of a soybean liquid or suggestion that a soybean liquid having a particular particle size distribution is preferably used. In actual, improvement in feeling at eating such as texture on the tongue, melting feeling in the mouth and the like can not be expected for a yoghurt-like fermented food obtained by this method.

Patent Document 1: JP 1-128759A

Patent Document 2: JP 58-32849A

### SUMMARY OF THE INVENTION

An object of the present invention is to provide a lactic acid-fermented soybean liquid composition which is free of a rough texture on the tongue resulting from soybean powder, is smooth, and has good melting feeling in the mouth and soft texture, despite the use of soybean powder.

The present inventor conducted various investigations focusing on the mechanism of protein coagulation and agglomeration in a soybean powder-water mixture obtained by dissolving soybean powder in water, in order to achieve the above object, and has found that suppression of initial coagulation of soybean protein in a lactic-acid fermentation process of a soybean liquid is important. The inventor has then found that, in the case of preparing a soybean liquid containing particles having a particle size of a certain level or lower in the early stage of fermentation and performing lactic acid fermentation in the presence of 0.05 to 0.5% (w/v) of an alkaline metal salt(s), particle size of particles in a lactic acid-fermented soybean liquid composition is prevented from increasing, and thereby smoothness, melting feeling in the mouse when taken as food or drink, or hardness when crushing with the tongue or a spoon is remarkably improved; and thus completed the present invention.

In other words, the present invention relates to the followings:

(1) A lactic acid-fermented soybean liquid composition obtained by fermenting, by lactic acid bacteria, a soybean liquid in which a content of soybean particles having a particle size of 50 μm or larger is less than 5% by mass of all soybean particles, under the condition where one or two or more kinds of alkaline metal salts are present in 230 ppm or more in terms of alkaline metals.

(2) The lactic acid-fermented soybean liquid composition according to (1), wherein a pH is 3.0 to 5.5 and a breaking strength is 9.0 gf or lower.

(3) The lactic acid-fermented soybean liquid composition according to (1) or

(2), wherein the content of particles having a particle size of 100 μm or larger is less than 1% by mass of all particles.

(4) A method for producing a lactic acid-fermented soybean liquid composition, comprising the steps of: homogenizing, sterilizing, and then further homogenizing a soybean powder-mixed liquid to obtain a soybean liquid; and fermenting the obtained soybean liquid by lactic acid bacteria, under the condition where one or two or more kinds of alkaline metal salts are present in 230 ppm or more in terms of alkaline metals.

(5) The method for producing a lactic acid-fermented soybean liquid composition according to (4), wherein the homogenization of the soybean powder-mixed liquid before sterilizing is performed at a pressure of 30 to 100 MPa and the homogenization after sterilizing is performed at a pressure of 5 to 50 MPa.

(6) The method for producing a lactic acid-fermented soybean liquid composition according to (4) or (5), wherein the alkaline metal salts are one or two or more kinds of selected from the group consisting of sodium chloride, potassium chloride, sodium nitrate, sodium acetate, sodium sulfate, and sodium hydrogen carbonate.

### BRIEF DESCRIPTION OF THE DRAWINGS

FIG. 1 shows particle size distributions of lactic acid-fermented soybean liquid compositions of the present invention and Comparative Example.

### DESCRIPTION OF THE PREFERRED EMBODIMENT

A lactic acid-fermented soybean liquid composition and a production method of the composition according to the present invention will be described in detail below.

### (Soybean Powder)

The soybean powder used in the present invention refers to that obtained by grinding soybeans by an arbitrary method. Soybeans may be whole soybeans with the hull, partially or totally dehulled soybeans, or soybeans which have been subjected to an arbitrary treatment. For example, various low-purified soybean powders such as powder obtained from whole soybeans are commercially available as raw material for the production of soybean curd, soymilk-like drink and the like, which do not generate bean curd refuse and are richer in nutrients and fiber than those obtained from dehulled or purified soybeans.

### (Soybean Powder-Mixed Liquid)

The soybean powder-mixed liquid used in the present invention can be prepared by an arbitrary method using the soybean powder described above as a raw material. For example, water, preferably hot water at 60 to 70° C., is added to the soybean powder so as to dissolve the soybean powder in the water at an arbitrary concentration, for example, preferably 6 to 16% (w/v), more preferably 10 to 16% (w/v) thereby to prepare the soybean powder-water mixed liquid.

### (Soybean Liquid)

The soybean liquid used in the present invention is obtained by homogenizing, sterilizing, and then further homogenizing the soybean powder-mixed liquid described above.

### (Homogenization Treatment)

Since a soybean powder-water mixture prepared using, as raw material, usual soybean powder which has not been subjected to an arbitrary particular treatment in order to remarkably improve solubility in water contains large amounts of fiber and particles having a large particle size and lacks smoothness, the mixture is preferably subjected to a homogenization treatment before fermentation. The homogenization treatment may be conducted using, for example, an apparatus such as a homogenizer and the like under the condition where the pressure is 30 to 100 MPa and preferably 40 to 60 MPa.

### (Sterilization Treatment)

After particle sizes of the particles in the soybean powder-mixed liquid are reduced by the homogenization treatment, a sterilization treatment is conducted. The sterilization treatment may be conducted, for example, by an indirect high temperature flash sterilization system or a direct high temperature flash sterilization system. The heating temperature is preferably 120 to 140° C., and the heating time is preferably 2 to 60 seconds.

### (Re-Homogenization Treatment)

After that, the re-homogenization treatment is conducted. The re-homogenization treatment may be conducted using, for example, an apparatus such as a homogenizer and the like under the condition where the pressure is 5 to 50 MPa and preferably 8 to 12 MPa. By thus conducting the treatment, a smoother soybean liquid may be prepared. In the present invention, it is important that homogenization at a pressure of 30 to 100 MP is followed by sterilization and then homogenization is conducted again at 5 to 50 MPa. In this way, a soybean liquid in which the content of the soybean particles having a particle size of 50 μm or larger is less than 5% in all soybean particles is easily obtained.

### (Alkaline Metal Salts)

In order to put the present invention into practice, lactic acid bacteria are added to the soybean liquid prepared as described above and the resulting composition is lactic acid-fermented under the condition where one or two or more kinds of alkaline metal salts are present in 230 ppm or more, and preferably 390 ppm or more in terms of alkaline metals.

### (Kinds of Alkaline Metal Salts)

The metal species of alkaline metal salts used in the present invention include arbitrary alkaline metals which can prevent particles in the lactic acid-fermented soybean liquid composition from coagulation and flocculation, thereby to provide smoothness and good melting feeling in the mouth when taken as food or drink and improve the hardness when crushing with the tongue or a spoon. Such metal species are exemplified by sodium and/or potassium.

The alkaline metal salts used in the present invention may be one or two or more kinds selected from the group consisting of arbitrary alkaline metal salts, for example, sodium chloride, potassium chloride, sodium nitrate, sodium acetate, sodium sulfate, and sodium hydrogen carbonate. Among them, sodium chloride or potassium chloride is particularly preferable. These alkaline metal salts may be used alone or in combination. The timing of addition of the alkaline metal salt(s) is preferably after the heat sterilization and cooling of the soybean liquid. Alternatively, the alkaline metal salt(s) may be added during the production of the soybean liquid. The alkaline metal salt(s) may be added, dividing into several times, as required.

### (Addition Amount of Alkaline Metal Salt(s))

Although the most suitable addition amount of the alkaline metal salt(s) used in the present invention varies depending on the kinds of soybean powder used, the kinds of lactic acid bacteria used, or the fermentation conditions, in order to obtain the effect described above, one or two or more kinds of alkaline metal salts are preferably present in 230 ppm or more, and more preferably 390 ppm or more in terms of alkaline metal(s) when the soybean liquid is lactic acid-fermented. This amount of alkaline metal(s) corresponds to 0.058% (w/w) or more of sodium chloride when sodium chloride is used alone, 0.075% (w/w) or more of potassium chloride when potassium chloride is used alone, and 0.136% (w/w) or more of sodium acetate when sodium acetate is used alone. By performing the lactic acid fermentation under the condition where alkaline metal(s) are present in 230 ppm or more, and more preferably 390 ppm or more, particle size of particles in the lactic acid-fermented soybean liquid composition is prevented from increasing and smoothness, melting feeling in the mouth when taken as food or drink, and hardness when crushing with the tongue or a spoon are improved. When the amount of the alkaline metal(s) is less than 230 ppm, the effects as described above are not achieved sufficiently. There is no upper limit of the amount of the alkaline metal(s), as long as the desired effect on improving the texture is obtained. However, it is actually preferable to determine the most appropriate amount of the alkaline metal(s), considering the balance of tastes such as a salty taste and the like due to the alkaline metal salt(s), and others. Although the most appropriate amount differs depending on other ingredients blended, the alkaline metal salt(s) may be blended in an amount in the range of preferably 230 to 2300 ppm.

### (Particle Size of Soybean Powder in Soybean Liquid)

For the soybean liquid used as a raw material in the present invention, it is important that the content of soybean particles having a particle size of 50 μm or larger is less than 5% of all soybean particles. In other words, a soybean liquid in which a proportion of soybean particles having a particle size of 50 μm or larger exceeds 5% in the particle size distribution gives a rough texture and also tends to be poor in homogeneity stability, regardless of whether or not lactic acid fermentation is conducted, and therefore, with the soybean liquid the object of the present invention is not achieved. Further, even when such alkaline metal salt(s) described above are added to such soybean liquid and the resulting composition is lactic acid-fermented, smoothness or melting feeling in the mouth when taken as food or drink is insufficient.

On the contrary, when the alkaline metal salt(s) described above are added to a soybean liquid in which a proportion of soybean particles having a particle size of 50 μm or larger is less than 5% of all soybean particles in the particle size distribution and the resulting composition is lactic acid-fermented, the particle size of particles in the lactic acid-fermented soybean liquid composition does not increase even when the fermentation proceeds, so that a lactic acid-fermented soybean liquid composition which is smooth, has good melting feeling in the mouth when taken as food or drink and improved hardness when crushing with the tongue or a spoon may be obtained. The particle size distribution may be measured using a particle size distribution measurement apparatus, for example, Shimadzu Laser Diffraction Particle Size Analyzer (SALD-2200-WJA1: V1.02, manufactured by Shimadzu Corporation).

### (Lactic Acid Bacteria)

The lactic acid bacteria used in the present invention include various known lactic acid bacteria, for example, one or two or more of Bifidobacterium spp., Streptococcus thermophilus, Lactobacillus acidophilus, Lactobacillus casei, Lactococcus lactis subsp. lactis, Lactococcus lactis subsp. cremoris, Lactococcus lactis subsp. lactis biovar. diacetylactis, Lactobacillus casei subsp. casei, Lactobacillus plantarum, Streptococcus spp. bacteria, Lactococcus spp. bacteria, Leukonostock spp., Lactobacillus spp. bacteria, Enterococcus spp. bacteria, and the like.

### (Lactic Acid Fermentation)

Lactic acid fermentation may be conducted by known methods, and most appropriate conditions can be selected depending on the kinds of lactic acid bacteria added and the physical properties required for a lactic acid-fermented soybean liquid composition. For example, there may be mentioned a method in which lactic acid bacteria are added to a soybean liquid containing the above-described alkaline metal salt(s) and fermentation is performed for preferred duration under preferred culture conditions, for example, at 30 to 35° C. for 4 hours or more, while particle size distribution, pH, breaking strength and the like of the fermentation product are measured appropriately. A lactic acid-fermented soybean liquid composition having a favorable texture and physical properties is thus obtained.

The amount of lactic acid bacteria to be added is preferably 0.01 to 0.1% (w/w).

(Particle Size of Particles Derived from Soybean Powder in Lactic Acid-Fermented Soybean Liquid Composition)

According to the present invention, a lactic acid-fermented soybean liquid composition in which the content of the particles having a particle size of 100 μm or larger is less than 1% of all particles is easily obtained. This composition does not have rough texture, is good in homogeneity stability, is smooth and sufficiently excellent in melting feeling in the mouth when taken as drink or food, and has a soft feeling when crushing with the tongue or a spoon.

### (Breaking Strength of Lactic Acid-Fermented Soybean Liquid Composition)

The softness when crushing with the tongue or a spoon may be evaluated from, for example, breaking strength expressed by breaking force (gf) measured under a particular condition with a creep meter (rheometer), as an index. The breaking strength is affected by differences in raw materials used, formulation ratios, kinds of lactic acid bacteria (bacterium) or fermentation conditions used, and the like. Using the method of the present invention, however, a lactic acid-fermented soybean liquid composition having a lower breaking strength and a softer feeling is obtained as compared with that obtained without using the method of the present invention. It is preferred that the lactic acid-fermented soybean liquid composition according to the present invention has a breaking strength of 9.0 gf or lower, preferably 4.5 to 8.0 gf, since the very soft feeling when crushing with the tongue or a spoon can be obtained. The method of measurement of breaking strength using a creep meter (rheometer) will be specifically explained. A breaking force is measured by inserting a cylindrical plunger (P-6; φ8 mm/22 mm) in a lactic acid-fermented soybean liquid composition obtained by fermentation in a certain container with a sample-stage elevation rate of 1 mm/sec to break the composition, and this breaking force (gf) is used as a breaking strength, an index of hardness. The creep meter (rheometer) usable in the measurement is RE-3305 manufactured by Yamaden Co., Ltd.

### (pH of Lactic Acid-Fermented Soybean Liquid Composition)

In addition, the lactic acid-fermented soybean liquid composition obtained in the present invention preferably has a pH of 3.0 to 5.5. The lactic acid-fermented soybean liquid composition at pH of 3.0 to 5.5 has appropriate acid taste similar to yoghurt and is excellent in texture and taste. Known pH adjusting agents (acids, alkali) may be used during or after fermentation to finely adjust the pH of the lactic acid-fermented soybean liquid composition within the preferable range described above.

The lactic acid-fermented soybean liquid composition described above can be used as raw material for various kinds of food or drink products.

The food or drink products are not particularly limited, but include, for example, yoghurts, bavarois, jellies, sherbets, ice creams, lactic acid beverages, beverages such as soft drinks (including concentrated straight solution and powders for preparing of these food or drink products), soups, various kinds of condiments such as sauces, mayonnaises, dressings and the like, noodles such as soba noodles, udon noodles, Chinese noodles, instant noodles and the like, semi-solid food products such as gummy candies and the like, paste-form foods, gums, solid food products such as supplements and the like.

### EXAMPLES

Examples and Comparative Example will then be provided in order to illustrate the present invention more specifically, but the present invention is not limited by Examples below.

### Example 1

### Production of Lactic Acid-Fermented Soybean Liquid Composition

### Investigation of Addition Concentration

### 1. Preparation of Soybean Liquid

Hot water at 60 to 70° C. was added to whole-grain soybean powder so as to dissolve the powders to be at 10% (w/v), and then a homogenization treatment was conducted with a homogenizer (manufactured by Izumi Food Machinery Co., Ltd.) at 50 MPa.

The soybean liquid which had been subjected to the homogenization treatment was then sterilized by the indirect high temperature flash sterilization system at 130° C. for 50 seconds and then re-homogenized (15 MPa) with a homogenizer (manufactured by Izumi Food Machinery Co., Ltd.). The soybean liquid obtained had a soluble protein content of 6.5% (w/v) and a pH of 6.8. The particle size distribution was such that the content of soybean particles having a particle size of 50 μm or larger was 4% of all soybean particles.

### 2. Lactic Acid Fermentation

To the soybean liquid prepared above, sodium chloride was added at the concentration of 0.05 to 0.5% (w/v) as shown in Table 1. The addition amounts, calculated relative to the amount of soluble protein, were about 1.5 to 10.0% and also corresponded to 230 to 2300 ppm in terms of an alkaline metal.

After each 100 mL of the soybean liquids containing sodium chloride at the respective concentrations was put into a sterile plastic cup (4.5-ounce specimen container, manufactured by FALCON), 1.0 mg of commercially available lactic acid bacteria for yoghurt (YO-MIX505, manufactured by Danisco) were added to the soybean liquid, statically cultured at 40° C. overnight, and then cooled at 5° C. for 5 hours in a refrigerator to obtain a yoghurt-like lactic acid-fermented soybean liquid composition (the present invention). The same procedure was conducted without adding sodium chloride to obtain a lactic acid-fermented soybean liquid composition (Comparative Example). The pH and viable cell count of the lactic acid-fermented soybean liquid compositions obtained were measured. The results are almost the same for all the samples, as shown in Table 1, and it was found that lactic acid bacteria propagated well independently of the amount of sodium chloride added. Both samples were subjected to the following evaluations.

TABLE 1

| | Comparative | | | | | | |
|---|---|---|---|---|---|---|---|
| Sodium chloride | Example | The present invention | | | | | |
| concentration | 0% | 0.058% | 0.1% | 0.2% | 0.3% | 0.4% | 0.5% |
| Na⁺ ion (ppm) | 0 | 230 | 390 | 790 | 1180 | 1570 | 1970 |
| pH | 4.8 | 4.8 | 4.8 | 4.7 | 4.7 | 4.7 | 4.7 |
| Cell count | 1.58 × 10⁷ | 1.58 × 10⁷ | 1.57 × 10⁷ | 1.61 × 10⁷ | 1.56 × 10⁷ | 1.46 × 10⁷ | 1.57 × 10⁷ |
| Breaking strength | 8.0 | 6.1 | 5.9 | 5.2 | 4.5 | 4.6 | 4.6 |
| (gf) | | | | | | | |
| Melting feeling in | B | A | A | A | A | A | A |
| the mouth | | | | | | | |
| Smoothness | C | B | A | A | A | A | A |

A: Excellent, B: Good, C: Poor

### 3. Organoleptic Evaluation of Lactic Acid-Fermented Soybean Liquid Compositions

The lactic acid-fermented soybean liquid compositions obtained were evaluated in terms of “melting feeling in the mouth” and “smoothness” by organoleptic examination. The results are shown in Table 1. The evaluation was made in 3 grades. The result showed that the lactic acid-fermented soybean liquid compositions obtained by adding sodium chloride at 0.05% (w/v) or more were excellent in melting feeling in the mouth and smoothness. On the other hand, the lactic acid-fermented soybean liquid composition of Comparative Example was shown to be good in melting feeling in the mouth but poor in smoothness. When the melting feeling in the mouth was compared between Comparative Example and the present invention, a better melting feeling in the mouth with a softer feeling was obtained in the present invention.

When the same examination as above was performed with using as a starting raw material a soybean liquid in which the content of the soybean particles having a particle size of 50 μm or larger exceeded 5% of all soybean particles, it was confirmed that the lactic acid-fermented soybean liquid composition obtained was poor in terms of the melting feeling in the mouth and the smoothness.

### 4. Evaluation of Breaking Strength of Lactic Acid-Fermented Soybean Liquid Compositions

The breaking strength of the soybean protein curd of the lactic acid-fermented soybean liquid composition thus obtained was measured with a creep meter (rheometer) (RE-3305, manufactured by Yamaden Co., Ltd.). Specifically, a breaking force was measured by inserting a cylindrical plunger (P-6; φ8 mm/H22 mm) in the yoghurt-like whole-grain lactic acid-fermented soybean liquid composition obtained by lactic acid fermentation in the above-described cup with a sample-stage elevation rate of 1 mm/sec to break the composition, and this breaking force (gf) was used as a breaking strength, that is, an index of hardness. The results are shown in Table 1. The breaking strength decreased gradually as increasing the amount of sodium chloride added, and became constant when the sodium chloride was added at 0.3% (w/v) or more. Specifically, the breaking strength was about 8.0 gf when no sodium chloride was added, whereas the breaking strength was 6.1 gf when the sodium chloride was added at 0.058% (w/v) and 4.5 gf at 0.3% (w/v) with a decrease to nearly 50%. The results showed that the lactic acid-fermented soybean liquid compositions obtained with adding sodium chloride at 0.05% (w/v) or more had much softer physical property as compared with that of Comparative Example without adding sodium chloride.

### 5. Measurement of Particle Size Distribution of Lactic Acid-Fermented Soybean Liquid Compositions

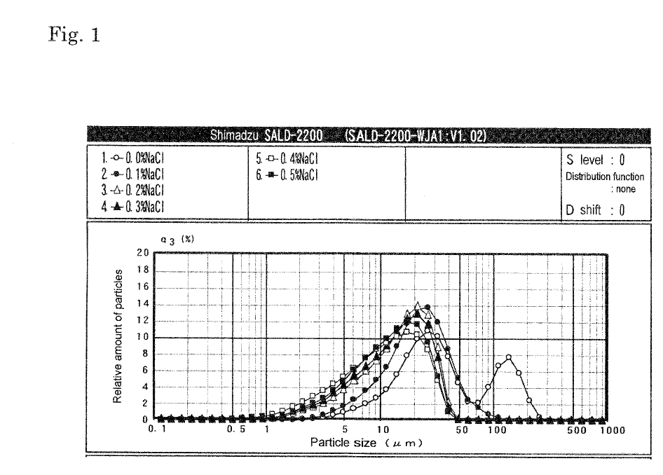

The results of particle size distribution measurement using Shimadzu Laser Diffraction Particle Size Analyzer (SALD-2200-WJA1:V1.02, manufactured by Shimadzu Corporation) of the lactic acid-fermented soybean liquid compositions of soybean protein are shown in FIG. 1 and Table 2.

TABLE 2

| | |
|---|---|
| Sodium chloride | Particle size (μm) |

| | | |
|---|---|---|
| concentration | Average | 95D |

| | | | |
|---|---|---|---|
| Comparative | 0% | 36.391 | 147.909 |
| Example | | | |
| The present | 0.1% | 20.317 | 44.641 |
| invention | 0.2% | 13.360 | 29.800 |
| | 0.3% | 12.277 | 28.605 |
| | 0.4% | 9.924 | 26.256 |
| | 0.5% | 11.140 | 26.792 |

Table 2 shows the 95% D values based on the particle size distribution profiles of the respective lactic acid-fermented soybean liquid compositions. The 95% D value refers to the maximum diameter of particles whose particle size is within 95% from the smallest particle size in the particle size distribution profiles. For example, it means that when the 95% D value is 100, the maximum particle diameter of particles whose particle size is within 95% from the smallest particle size in the lactic acid-fermented soybean liquid composition is 100 μm and that the lactic acid-fermented soybean liquid composition contains particles having a particle size of 100 μm or larger at 5% of all particles.

Table 2 shows that the 95% D values of all the lactic acid-fermented soybean liquid compositions containing no sodium chloride were much larger than 100 and large particles having a particle size of 140 μm or larger accounted for 5% of all particles. As shown in FIG. 1, particles having a particle size of 100 μm or larger represent a peak in the particle size distribution and account for a large proportion. On the other hand, it was shown that for all lactic acid-fermented soybean liquid compositions produced by adding sodium chloride at 0.05% (w/w) or more, the 95% D values were largely smaller than 100, that is to say, particles having a particle size of 50 μm or larger accounted for less than 5% of all particles in the particle size distribution. Also shown in FIG. 1, for the lactic acid-fermented soybean liquid compositions produced by adding sodium chloride at 0.05% (w/w) or more, no particle having a particle diameter of 100 μm or larger was confirmed in the particle size profile, turned out that the particle size as a whole was very small.

According to a comparison of average particle size, the average particle size was about 36 μm for the sodium chloride-free group (Comparative Example) while it was about 10 to 20 μm for the sodium chloride-containing group (the present invention). Especially for the sodium chloride-free composition, particles having a particle size of around 70 to 200 μm were present, coagulated particles were observed even macroscopically, and the composition was rough not only in terms of the texture but also the appearance. Based on the result shown in FIG. 1 and Table 2, it was thus shown that the proportion of particles having a particle size of 100 μm or larger in the particle size distribution largely varied depending on the amounts of alkaline metal(s) added.

### Example 2

### Production of Lactic Acid-Fermented Soybean Liquid Composition

### Comparison of Coagulation Tendency Depending on Fermentation Duration

### 1. Preparation of Soybean Liquid

Hot water at 60 to 70° C. was added to dehulled soybean powder to dissolve it at 12% (w/v) and the mixture was homogenized (50 MPa) with a homogenizer (Izumi Food Machinery Co., Ltd.).

The homogenized soybean liquid was then sterilized by the indirect high temperature flash sterilization system at 130° C. for 50 seconds, and then re-homogenized (15 MPa) with a homogenizer (manufactured by Izumi Food Machinery Co., Ltd.). The soybean liquid obtained had a soluble protein content of 5.2% (w/v) and a pH of 6.8. The particle size distribution was such that the content of soybean particles having a particle size of 50 μm or more was 4% of all soybean particles.

### 2. Lactic Acid Fermentation

Sodium chloride was dissolved in the prepared soybean liquid at a concentration of 0.1% (w/v). After 100 mL of the soybean liquid which had been thus prepared was put into a sterile plastic cup, 1.0 mg of commercially available lactic acid bacteria for yoghurt (YO-MIX204, manufactured by Danisco) was added and cultured at 40° C. After 3 hours, 5 hours and 7 hours of culture, pH of the lactic acid-fermented soybean liquid composition (the present invention) was measured. As Comparative Example, the same procedures as above were conducted with using a soybean liquid of the sodium chloride-free group. As shown in Table 3, the pH of the lactic acid-fermented soybean liquid compositions after fermentation for the respective durations was similar, regardless of whether or not sodium chloride was added.

### 3. Measurement of Particle Size Distribution of Lactic Acid-Fermented Soybean Liquid Composition

In accordance with the method in Example 1, the particle size distribution was measured for the respective lactic acid-fermented soybean liquid compositions. As shown in Table 3, it was shown that soybean protein coagulated and the particle size gradually increased due to the reduction in pH with the progress of fermentation with lactic acid bacteria. Specifically, the average particle size was already 21 μm and particles having a particle size larger than 120 μm accounted for 5% of all particles, at pH 4.6 after 3 hours fermentation. The particle size further increased according to the duration of fermentation, and after 7 hours fermentation, the average particle size increased up to about 40 μm and particles having a particle size larger than 210 μm accounted 5% of all particles.

On the other hand, for the lactic acid-fermented soybean liquid compositions containing sodium chloride according to the present invention, the average particle size was very small, only 3.8 μm, at pH 4.6 after 3 hours fermentation, and further it increased only up to about 6.5 μm even when fermentation was progressed 7 hours and pH decreased. It was found that particles having a particle size larger than about 20 μm accounted for only 5% of all particles and the particle size as a whole was extremely small even after 7 hours fermentation.

In other words, it was found that addition of an alkaline metal salt (sodium chloride) to a soybean liquid suppressed the coagulation in the early stage of soybean protein due to the reduction of pH and prevented the small coagulated particles in the early stage from gathering to agglomerate, enabling preparation of a lactic acid-fermented soybean liquid having a small particle size.

TABLE 3

| Without sodium chloride added | | | | With sodium chloride added | | | |
|---|---|---|---|---|---|---|---|
| (Comparative Example) | | | | The present invention | | | |
| Culture | | Particle size (μm) | | Culture | | Particle size (μm) | |
| duration | pH | Average | 95D | duration | pH | Average | 95D |
| 3 hours | 4.65 | 21.846 | 123.831 | 3 hours | 4.61 | 3.821 | 12.787 |
| 5 hours | 4.49 | 34.174 | 172.070 | 5 hours | 4.47 | 5.933 | 22.199 |
| 7 hours | 4.41 | 39.250 | 214.562 | 7 hours | 4.37 | 6.490 | 22.799 |

### Example 3

### Production of Lactic Acid-Fermented Soybean Liquid Composition

### Use of Various Alkaline Metal Salts

### 1. Preparation of Soybean Liquid

Hot water at 60 to 70° C. was added to dehulled soybean powder to dissolve it at 12% (w/v) and the mixture was then homogenized (50 MPa) with a homogenizer (Izumi Food Machinery Co., Ltd.).

The homogenized soybean liquid was then sterilized by the indirect high temperature flash sterilization system at 130° C. for 50 seconds and then re-homogenized (15 MPa) with a homogenizer (manufactured by Izumi Food Machinery Co., Ltd.). The soybean liquid obtained had a soluble protein content of 5.2% (w/v) and a pH of 6.8. In addition, the particle size distribution was such that the content of soybean particles having a particle size of 50 μm or larger accounted for 4% of all soybean particles. The soybean liquid not subjected to re-homogenization contained particles having a large particle size and particles having a particle size of 50 μm or larger accounted for more than 5%.

### 2. Lactic Acid Fermentation

Various kinds of alkaline metal salts (sodium chloride, sodium nitrate, sodium sulfate, sodium acetate, sodium hydrogen carbonate (baking soda), and potassium chloride) were dissolved in the prepared soybean liquid at an alkaline metal concentration of 10 mM (229.9 ppm as an alkaline metal). After 100 ml of the prepared soybean liquid was put into a sterile plastic cup, 1.0 mg of commercially available lactic acid bacteria for yoghurt (YO-MIX204, manufactured by Danisco) was added. pH of the lactic acid-fermented soybean liquid compositions was measured after the fermentation at 40° C. for 8 hours. As shown in Table 4, the pH values of the lactic acid-fermented soybean liquid compositions after the fermentation were similar for all the samples, regardless of whether or not sodium chloride was added and/or the differences in fermentation durations.

As shown in Table 4, all the groups containing any of the alkaline metal salts was improved in the melting feeling in the mouth by the organoleptic evaluation. While the breaking strength of the lactic acid-fermented soybean liquid compositions containing no alkaline metal salt was 18.5 gf, the breaking strength of the lactic acid-fermented soybean liquid compositions containing any of the alkaline metal salts reduced largely to 7.7 to 9.0 gf. The breaking strength decreased to the similar level with sodium chloride or potassium chloride both of which are chloride compounds. With all the other anionic compounds (sodium nitrate, sodium acetate, sodium sulfate, and sodium hydrogen carbonate), the breaking strength decreased, although with some differences in the effect of decreasing breaking strength. The particle size distribution of the composition according to the present invention was in a smaller range than that of Comparative Example and it was confirmed that the composition of the present invention was excellent also in smoothness by the organoleptic evaluation.

The above results showed that fermentation after the addition of various kinds of alkaline metal salts provided lactic acid-fermented soybean liquid compositions with improved melting feeling in the mouth, decreased breaking strength and excellent smoothness.

TABLE 4

| | | | | Melting | |
|---|---|---|---|---|---|
| | | | Breaking | feeling in | |
| | Alkaline metal salt | % (w/v) | strength (gf) | the mouth | Smoothness |
| Comparative | None | — | 18.5 | C | C |
| Example | | | | | |
| The present | Sodium chloride | 0.058 | 7.9 | A | B |
| invention | Potassium chloride | 0.075 | 7.9 | A | B |
| | Sodium nitrate | 0.085 | 8.1 | B | B |
| | Sodium acetate | 0.136 | 9.0 | B | B |
| | Sodium sulfate | 0.071 | 7.7 | A | B |
| | Sodium hydrogen | 0.084 | 8.6 | B | B |
| | carbonate | | | | |

A: Excellent, B: Good, C: Poor

### INDUSTRIAL APPLICABILITY

According to the present invention, a lactic acid-fermented soybean liquid composition which is smooth and has good melting feeling in the mouth and soft texture without rough texture on the tongue derived from soybean powder, can be easily obtained in spite of the use of soybean powder.

1. A lactic acid-fermented soybean liquid composition obtained by fermenting, by lactic acid bacteria, a soybean liquid in which a content of soybean particles having a particle size of 50 μm or larger is less than 5% by mass of all soybean particles, under the condition where one or two or more kinds of alkaline metal salts are present in 230 ppm or more in terms of alkaline metals.

2. The lactic acid-fermented soybean liquid composition according to claim 1, wherein a pH is 3.0 to 5.5 and a breaking strength is 9.0 gf or lower.

3. The lactic acid-fermented soybean liquid composition according to claim 1, wherein the content of particles having a particle size of 100 μm or larger is less than 1% by mass of all particles.

4. A method for producing a lactic acid-fermented soybean liquid composition, comprising the steps of: homogenizing, sterilizing, and then further homogenizing a soybean powder-mixed liquid to obtain a soybean liquid, and fermenting the obtained soybean liquid by lactic acid bacteria, under the condition where one or two or more kinds of alkaline metal salts are present in 230 ppm or more in terms of alkaline metals.

5. The method for producing a lactic acid-fermented soybean liquid composition according to claim 4, wherein the homogenization of the soybean powder-mixed liquid before sterilizing is performed at a pressure of 30 to 100 MPa and the homogenization after sterilizing is performed at a pressure of 5 to 50 MPa.

6. The method for producing a lactic acid-fermented soybean liquid composition according to claim 4, wherein the alkaline metal salts are one or two or more kinds of selected from the group consisting of sodium chloride, potassium chloride, sodium nitrate, sodium acetate, sodium sulfate, and sodium hydrogen carbonate.

7. The method for producing a lactic acid-fermented soybean liquid composition according to claim 5, wherein the alkaline metal salts are one or two or more kinds of selected from the group consisting of sodium chloride, potassium chloride, sodium nitrate, sodium acetate, sodium sulfate, and sodium hydrogen carbonate.

8. The lactic acid-fermented soybean liquid composition according to claim 2, wherein the content of particles having a particle size of 100 μm or larger is less than 1% by mass of all particles.
